(19) United States
(12) Patent Application Publication
(10) Pub. No.: US 2025/0312635 A1
(43) Pub. Date: Oct. 9, 2025

(54) BATTERY PACK

(71) Applicant: SAMSUNG SDI CO., LTD., Yongin-si (KR)

(72) Inventor: Ho Ryong HWANG, Suwon-si (KR)

(21) Appl. No.: 18/924,319

(22) Filed: Oct. 23, 2024

(30) Foreign Application Priority Data
Apr. 9, 2024 (KR) 10-2024-0048149

(51) Int. Cl. A62C 35/02; A62C 3/16; H01M 50/271; H01M 50/383

(52) U.S. Cl. CPC A62C 35/02; A62C 3/16; H01M 50/271; H01M 50/383

(57) ABSTRACT

A battery pack includes a housing, a battery cell inside the housing and including a vent, an extinguishing member outside the housing and configured to supply an extinguishing material if the battery cell ignites, a cover between the battery cell and the extinguishing member, and a transfer member arranged in the cover and configured to transfer the extinguishing material supplied from the extinguishing member to the battery cell.

### CROSS-REFERENCE TO RELATED APPLICATION

The present application claims priority to and the benefit of Korean Patent Application No. 10-2024-0048149, filed on Apr. 9, 2024 in the Korean Intellectual Property Office, the entire disclosure of which is incorporated herein by reference.

### BACKGROUND

### 1. Field

Aspects of embodiments of the present disclosure relate to a battery pack.

### 2. Description of the Related Art

Secondary batteries are batteries that can be charged and discharged, unlike primary batteries that cannot be recharged. Low-capacity secondary batteries may be used in portable small electronic devices, such as smartphones, feature phones, laptop computers, digital cameras, and camcorders, while high-capacity secondary batteries are widely used as power sources for motor driving, such as for hybrid vehicles and electric vehicles, and batteries for power storage, or the like. The secondary battery includes an electrode assembly composed of a positive electrode and a negative electrode, a case that accommodates the electrode assembly, and an electrode terminal connected to the electrode assembly.

The secondary battery may be used in a battery pack formed of a plurality of unit battery cells connected in series and/or parallel to provide a high energy density. The battery pack may be formed by interconnecting the electrode terminals of a plurality of unit batteries to meet a desired amount of power, for example, to implement a high-power secondary battery for an electric vehicle.

The above-described information disclosed in the technology that forms the background of the present disclosure is provided to improve understanding of the background of the present disclosure, and thus may include information that does not constitute the related art.

### SUMMARY

According to an aspect of embodiments of the present disclosure, a battery pack that can improve extinguishing efficiency if a battery cell ignites is provided.

The above and other aspects and features of the present disclosure will be described in or will be apparent from the following description of some embodiments of the present disclosure.

According to one or more embodiments of the present disclosure, a battery pack includes a housing, a battery cell inside the housing and including a vent, an extinguishing member outside the housing and configured to supply an extinguishing material if the battery cell ignites, a cover between the battery cell and the extinguishing member, and a transfer member arranged in the cover and configured to transfer the extinguishing material supplied from the extinguishing member to the battery cell.

The vent may face the cover.

The cover may include a first cover body, a first groove passing through the first cover body, a second cover body connected to the first cover body and located between the first groove and the battery cell, and a second groove in the second cover body, connected to the first groove, and in which the extinguishing member is inserted.

The second cover body may protrude from the first cover body toward the battery cell.

A cross-sectional area of the second groove may be smaller than a cross-sectional area of the first groove.

The transfer member may include a transfer hole passing through the second cover body and facing the extinguishing member and the battery cell.

A cross-sectional area of the transfer hole may increase toward the battery cell.

The transfer hole may include a first transfer hole facing the extinguishing member and a second transfer hole connected to the first transfer hole and facing the battery cell.

A cross-sectional area of the first transfer hole may increase toward the extinguishing member, and a cross-sectional area of the second transfer hole may increase toward the battery cell.

The battery pack may further include a cap in the first groove and covering the extinguishing member.

The cap may include a cap body inserted into the first groove in a first direction and a support rib extending from the cap body in the first direction and in contact with the extinguishing member.

The cap body may include a first cap body seated on the second cover body, and a second cap body connected to the first cap body and facing the extinguishing member.

A thickness of the second cap body may be thinner than a thickness of the first cap body.

The cap body may be arranged in the first groove to be rotatable about the first direction, and the battery pack may further include a locking member configured to interwork with rotation of the cap body to selectively restrict the cap body from moving in a direction opposite to the first direction.

The cap may further include a lever extending from the cap body in the direction opposite to the first direction.

The locking member may include a guide rail passing through the second cover body and including a first end portion and a second end portion, a guide rod extending from the cap body, inserted in the guide rail, and movable toward the first end portion or the second end portion according to a rotational direction of the cap body, and a stopper rod extending from the guide rod, facing the guide rail when the guide rod is located at the first end portion, and facing the second cover body when the guide rod is located at the second end portion.

The first end portion and the second end portion may be spaced apart in a direction intersecting the first direction.

The guide rod may be arranged parallel to the first direction, and the stopper rod may be arranged to intersect the first direction.

The second cover body and the stopper rod may be sequentially arranged in the first direction.

### BRIEF DESCRIPTION OF THE DRAWINGS

The drawings attached to this specification illustrate some embodiments of the present disclosure, and further describe aspects and features of the present disclosure together with the detailed description of the present disclosure. However, the present disclosure is not be construed as being limited to the drawings.

FIG. 1 is an exploded perspective view schematically showing a configuration of a battery pack according to an embodiment of the present disclosure.

FIG. 2 is a perspective view schematically showing a configuration of a battery cell according to an embodiment of the present disclosure.

FIG. 3 is a cross-sectional view schematically showing a configuration of the battery cell of FIG. 2.

FIG. 4 is an exploded perspective view schematically showing a configuration of a cover, an extinguishing member, and a transfer member according to an embodiment of the present disclosure.

FIG. 5 is a cross-sectional view schematically showing a configuration of the cover, the extinguishing member, and the transfer member according to an embodiment of the present disclosure.

FIG. 6 is an exploded cross-sectional view schematically showing a configuration of the cover, the extinguishing member, and the transfer member shown in FIG. 5.

FIG. 7 is an enlarged view schematically showing a configuration of a transfer hole according to an embodiment of the present disclosure.

FIGS. 8 and 9 are views showing some other examples of the transfer hole shown in FIG. 7.

FIG. 10 is an enlarged view schematically showing a configuration of a cap according to an embodiment of the present disclosure.

FIGS. 11 and 12 are views schematically showing an operation process of the battery pack according to an embodiment of the present disclosure.

FIG. 13 is an exploded perspective view schematically showing a configuration of a battery pack according to another embodiment of the present disclosure.

FIG. 14 is an exploded perspective view schematically showing a configuration of a locking member of the battery pack of FIG. 13.

FIG. 15 is an exploded perspective view schematically showing a configuration of the locking member from a different viewpoint than FIG. 14.

FIGS. 16 and 17 are views schematically showing an operation process of the locking member of FIG. 14.

### DETAILED DESCRIPTION

Herein, some embodiments of the present disclosure will be described, in further detail, with reference to the accompanying drawings. The terms or words used in this specification and claims are not to be construed as being limited to the usual or dictionary meaning and are to be interpreted as having meaning and concept consistent with the technical idea of the present disclosure based on the principle that the inventor can be his/her own lexicographer to appropriately define the concept of the term.

The embodiments described in this specification and the configurations shown in the drawings are provided as some example embodiments of the present disclosure and do not necessarily represent all of the technical ideas, aspects, and features of the present disclosure. Accordingly, it is to be understood that there may be various equivalents and modifications that may replace or modify the embodiments described herein at the time of filing this application.

It is to be understood that when an element or layer is referred to as being “on,” “connected to,” or “coupled to” another element or layer, it may be directly on, connected, or coupled to the other element or layer, or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element, or the first element may be indirectly coupled or connected to the second element via one or more intervening elements.

In the figures, dimensions of the various elements, layers, etc. may be exaggerated for clarity of illustration. The same reference numerals designate the same or like elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B, and C,” “at least one of A, B, or C,” “at least one selected from a group of A, B, and C,” or “at least one selected from among A, B, and C” are used to designate a list of elements A, B, and C, the phrase may refer to any and all suitable combinations or a subset of A, B, and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It is to be understood that, although the terms “first,” “second,” “third,” etc. may be used herein to describe various elements, components, regions, layers, and/or sections, these elements, components, regions, layers, and/or sections are not to be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It is to be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (e.g., rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It is to be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all sub-ranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

References to two compared elements, features, etc. as being “the same” may mean that they are the same or substantially the same. Thus, the phrase “the same” or “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

When an arbitrary element is referred to as being arranged (or located or positioned) on the “above (or below)” or “on (or under)” a component, it may mean that the arbitrary element is placed in contact with the upper (or lower) surface of the component and may also mean that one or more other components may be interposed between the component and any arbitrary element arranged (or located or positioned) on (or under) the component.

In addition, it is to be understood that when an element is referred to as being “coupled,” “linked,” or “connected” to another element, the elements may be directly “coupled,” “linked,” or “connected” to each other, or one or more intervening elements may be present therebetween, through which the element may be “coupled,” “linked,” or “connected” to another element. In addition, when a part is referred to as being “electrically coupled” to another part, the part may be directly electrically connected to another part, or one or more intervening parts may be present therebetween such that the part and the another part are indirectly electrically connected to each other.

Throughout the specification, when “A and/or B” is stated, it means A, B, or A and B, unless otherwise stated. That is, “and/or” includes any or all combinations of a plurality of items enumerated. When “C to D” is stated, it means C or more and D or less, unless otherwise specified.

The terms used in the present specification are for describing embodiments of the present disclosure and are not intended to limit the present disclosure.

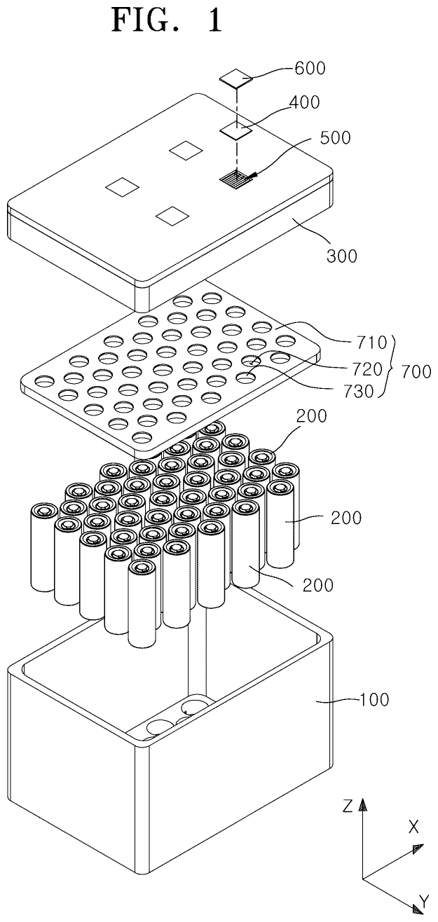

FIG. 1 is an exploded perspective view schematically showing a configuration of a battery pack according to an embodiment of the present disclosure.

Referring to FIG. 1, a battery pack according to the present embodiment includes a housing 100, a battery cell 200, a cover 300, an extinguishing member 400, and a transfer member 500.

A first direction described below is parallel to a Z-axis based on FIG. 1 and may refer to a direction from an upper side to a lower side. A second direction is a direction intersecting the first direction and may refer to, for example, any one of the directions parallel to an X-axis. In addition, a third direction is a direction intersecting the first and second directions and may refer to, for example, any one of the directions parallel to a Y-axis.

The housing 100 may form a general appearance of the battery pack and provide a space in which the battery cell 200 may be accommodated.

The housing 100 according to the present embodiment may be formed to have a box shape with an empty interior and an open side. The open side of the housing 100 may be disposed to face upward. However, a cross-sectional shape of the housing 100 is not limited to a rectangle, as shown in FIG. 1, and may be varied to have any of various shapes, such as polygonal, circular, and elliptical shapes.

The battery cell 200 may function as a unit structure that stores and supplies power in the battery pack.

Herein, an example in which the battery cell 200 is a cylindrical battery and a lithium-ion secondary battery will be described. However, the present disclosure is not limited thereto, and the battery cell 200 may be a lithium polymer battery or a prismatic battery, for example.

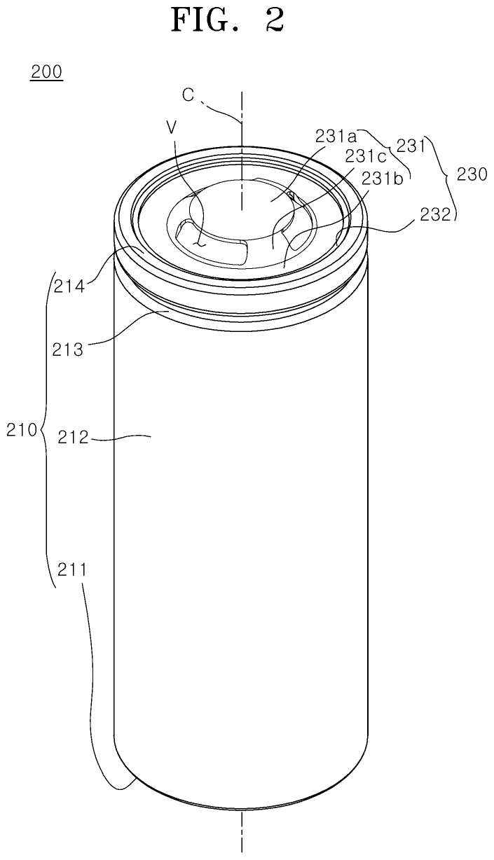

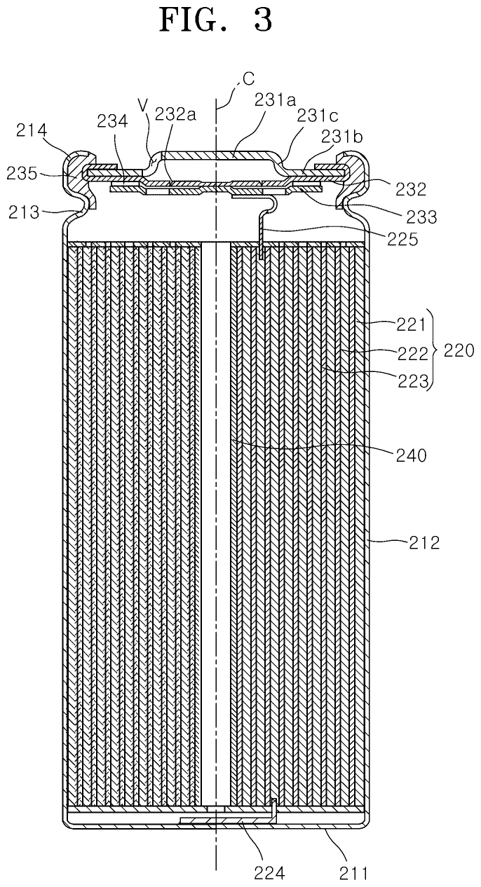

FIG. 2 is a perspective view schematically showing a configuration of the battery cell according to an embodiment of the present disclosure; and FIG. 3 is a cross-sectional view schematically showing a configuration of the battery cell of FIG. 2.

Referring to FIGS. 2 and 3, the battery cell 200 may include a cell case 210, an electrode assembly 220, and a cap assembly 230.

In an embodiment, the cell case 210 may include a generally circular bottom portion 211 and a side wall 212 extending by a length (e.g., a predetermined length) upward from the bottom portion 211. In an embodiment, the cell case 210 may be made of steel, a steel alloy, nickel-plated steel, a nickel-plated steel alloy, aluminum, or an aluminum alloy.

During a manufacturing process of the battery cell 200, an upper part of the cell case 210 may be open. Therefore, during an assembly process of the battery cell 200, the electrode assembly 220 may be integrated into a single structure and inserted into the cell case 210. Subsequently, an electrolyte may be additionally injected into the cell case 210.

A beading part 213 recessed in a direction of a central axis of the cap assembly 230 may be formed on an upper side of the cell case 210 to prevent or substantially prevent the cap assembly 230 from being separated to the outside. The beading part 213 may be disposed below the cap assembly 230. A crimping part 214 bent around (e.g., to surround) an edge portion of the cap assembly 230 may be formed above the beading part 213.

The electrode assembly 220 may be accommodated inside the cell case 210. The electrode assembly 220 may include or be referred to as an electrode, an electrode group, or a jelly roll. The electrode assembly 220 may include a negative electrode plate 221 coated with a negative electrode active material (e.g., graphite, carbon, etc.), a positive electrode plate 222 coated with a positive electrode active material (e.g., a transition metal oxide, such as LiCoO₂, LiNiO₂, LiMn₂O₄, etc.), and a separator 223 located between the negative electrode plate 221 and the positive electrode plate 222 to prevent or substantially prevent a short circuit and allow only lithium ions to move. In an embodiment, the negative electrode plate 221, the positive electrode plate 222, and the separator 223 may be wound into a generally cylindrical shape. In some examples, the negative electrode plate 221 may be a copper (Cu) foil, the positive electrode plate 222 may be an aluminum (Al) foil, and the separator 223 may be polyethylene (PE) or polypropylene (PP).

In an embodiment, a negative electrode tab 224 may be welded to the negative electrode plate 221. The negative electrode tab 224 may protrude and extend by a length (e.g., a predetermined length) downward from the electrode assembly 220. In an embodiment, a positive electrode tab 225 may be welded to the positive electrode plate 222. The positive electrode tab 225 may protrude and extend by a length (e.g., a predetermined length) upward from the electrode assembly 220. In an embodiment, the negative electrode tab 224 may be copper (Cu) or nickel (Ni), and the positive electrode tab 225 may be aluminum (Al).

In an embodiment, the negative electrode tab 224 may be welded to the bottom portion 211 of the cell case 210. Therefore, the cell case 210 may function as a negative electrode. In some examples, the negative electrode tab 224 may be ultrasonically or laser welded to the bottom portion 211 of the cell case 210. However, the positive electrode tab 225 may be welded to the bottom portion 211 of the cell case 210 and, in this case, the cell case 210 may function as a positive electrode.

In an embodiment, the electrode assembly 220 may further include a center pin 240. In an embodiment, the center pin 240 may be in the form of a hollow circular pipe and may be coupled to the center or approximately the center of the electrode assembly 220. This center pin 240 may be formed of steel, stainless steel, aluminum, an aluminum alloy, or polybutylene terephthalate (PBT), but a material is not limited thereto. The center pin 240 may suppress deformation of the electrode assembly 220 during charging and discharging of the secondary battery. The center pin 240 may function as a movement passage for gas generated inside the secondary battery. However, in some cases, the center pin 240 may be omitted.

The cap assembly 230 may seal an opening of the cell case 210 and protect the electrode assembly 220 from an external environment. For example, if an internal pressure of the cell case 210 increases above a reference pressure due to thermal runaway or ignition of the battery cell 200, the cap assembly 230 may rupture to discharge the internal gas of the cell case 210 to the outside. In some examples, the cap assembly 230 may also function as a positive terminal.

The cap assembly 230 may include a cap up 231, a vent plate 232, and a cap down 233.

The cap up 231 may function as a terminal electrically connected to an external device. In some examples, the cap up 231 may function as a positive terminal. In an embodiment, the cap up 231 may be made of aluminum or an aluminum alloy.

For example, the cap up 231 may include an inner body 231a, an outer body 231b, and a bridge 231c.

The inner body 231a may form generally or define a central portion of the cap up 231. For example, the inner body 231a may be formed in a generally disk shape. The inner body 231a may be disposed such that a central axis thereof matches a central axis C of the cell case 210.

The outer body 231b may form generally or define an edge of the cap up 231. For example, the outer body 231b may be formed in a generally hollow ring shape. A diameter of the outer body 231b may be greater than that of the inner body 231a. The outer body 231b may be disposed coaxially with the inner body 231a. In other words, a central axis of the outer body 231b may be disposed to match the central axis C of the inner body 231a and the cell case 210.

In an embodiment, the inner body 231a and the outer body 231b may be disposed to be spaced apart vertically. For example, the outer body 231b may be disposed below the inner body 231a. However, the inner body 231a and the outer body 231b may be disposed on a same plane.

The bridge 231c may be disposed between the inner body 231a and the outer body 231b, and may support the inner body 231a with respect to the outer body 231b. In an embodiment, the bridge 231c may be formed to have a rod shape with both, or opposite, end portions connected to an outer circumferential surface of an inner body 231a and an inner circumferential surface of the outer body 231b, respectively. The bridge 231c may be provided in plural. The plurality of bridges 231c may be arranged to be spaced apart at intervals (e.g., set intervals) along a circumference centered on the central axis C of the cell case 210. In an embodiment, the intervals between neighboring bridges 231c may be the same.

A vent V may be formed in the cap up 231. The vent V may discharge the internal gas to the outside when an abnormal internal pressure is generated inside the cell case 210 due to overcharging or the like.

The vent V according to the present embodiment may be formed to have a hole shape formed by passing through the cap up 231. For example, the vent V may be formed to have a hole shape passing through an area between the inner body 231a and the outer body 231b. The vent V may be provided in plural. The plurality of vents V may be individually disposed between neighboring bridges 231c. However, a number of vents V is not limited to that shown in FIG. 3 and may be varied to any of various numbers.

The vent plate 232 may be located below the cap up 231. The vent plate 232 may be in contact with (e.g., in close contact with), coupled to, or connected to a lower part of the cap up 231. For example, the vent plate 232 may be in contact with (e.g., in close contact with), coupled to, or connected to an edge of the cap up 231, that is, the outer body 232a, excluding a central part protruding upward in the cap up 231, that is, the inner body 231a. In an embodiment, the end portion of the vent plate 232 may extend in a curved manner around (e.g., to surround) the end portion of the outer body 232a. In an embodiment, the vent plate 232 may be made of aluminum or an aluminum alloy.

The vent plate 232 may include a notch 232a. The notch 232a may be formed to be concave from an outer surface of the vent plate 232 to a depth (e.g., a predetermined depth).

As the internal pressure of the battery cell 200 increases above a reference pressure (or a rupture pressure of the vent plate 232) due to thermal runaway or ignition of the battery cell 200, for example, the notch 232a may rupture and the discharge material generated inside the cell case 210 may sequentially pass through the notch 232a and the vent V to be discharged to the outside. Here, the discharge materials discharged from the vent V may include at least one of flames, gas, or smoke.

The cap down 233 may be located below the vent plate 232. The cap down 233 may be in contact with (e.g., in close contact with), connected to, or coupled to the vent plate 232. The cap down 233 may be electrically connected to the electrode assembly 220 through the positive electrode tab 225. The cap down 233 may be electrically connected to the vent plate 232 and the cap up 231. In an embodiment, the positive electrode tab 225 of the electrode assembly 220 may be welded to a lower surface of the cap down 233. In some examples, a lower surface of the cap down 233 may be ultrasonically and/or laser welded to the positive electrode tab 225. In some examples, the cap down 233 may be made of aluminum or an aluminum alloy.

In some examples, during thermal runaway or ignition of the battery cell 200, the vent plate 232 may be deformed by the internal pressure of the cell case 210, and the cap down 233 and the vent plate 232 may be electrically separated.

A first insulating member 234 may be installed between the vent plate 232 and the cap down 233. The first insulating member 234 may be located between the edge of the vent plate 232 and the edge of the cap down 233. The first insulating member 234 may insulate between the cap down 233 and the vent plate 232 if the vent plate 232 is deformed by the internal gas. In some examples, the first insulating member 234 may be formed of a resin material, such as polyethylene (PE), polypropylene (PP), or polyethylene terephthalate (PET), but a material is not limited thereto.

A second insulating member 235 may be installed on an upper side of the cell case 210. The second insulating member 235 may be located between an end portion of the vent plate 232 surrounding the outer body 231b of the cap up 231 and the cell case 210. Both, or opposite, sides of the second insulating member 235 may be in contact with (e.g., close contact with) the end portion of the vent plate 232 and inner side surfaces of the crimping part 214 and the beading part 213, respectively. The second insulating member 235 may insulate between the case 210 and the cap assembly 230. The second insulating member 235 may be formed of a resin material, such as polyethylene (PE), polypropylene (PP), or polyethylene terephthalate (PET), but a material is not limited thereto.

The battery cell 200 may be disposed inside the housing 100. For example, the battery cell 200 may be disposed in an internal space of the housing 100. The bottom portion 211 of the battery cell 200 may be disposed to face a bottom surface of the housing 100. The vent V located at an upper end portion of the battery cell 200 may be disposed to face the open side of the housing 100.

The battery cell 200 may be provided in plural. The plurality of battery cells 200 may be disposed side by side inside the housing 100. The plurality of battery cells 200 may be disposed in any of various patterns inside the housing 100, such as a grid shape or a zigzag shape. A number of the battery cells 200 may be varied in various ways, such as depending on a size of the housing 100, or the like.

The cover 300 may be coupled to the housing 100 and may close the internal space of the housing 100.

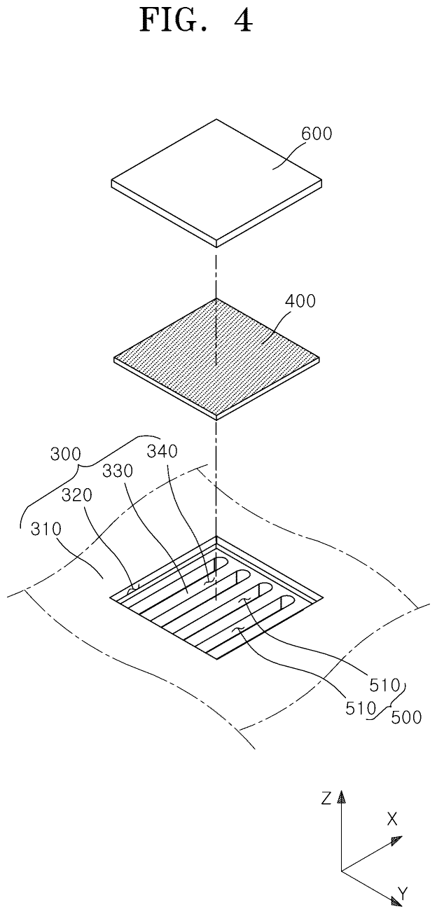

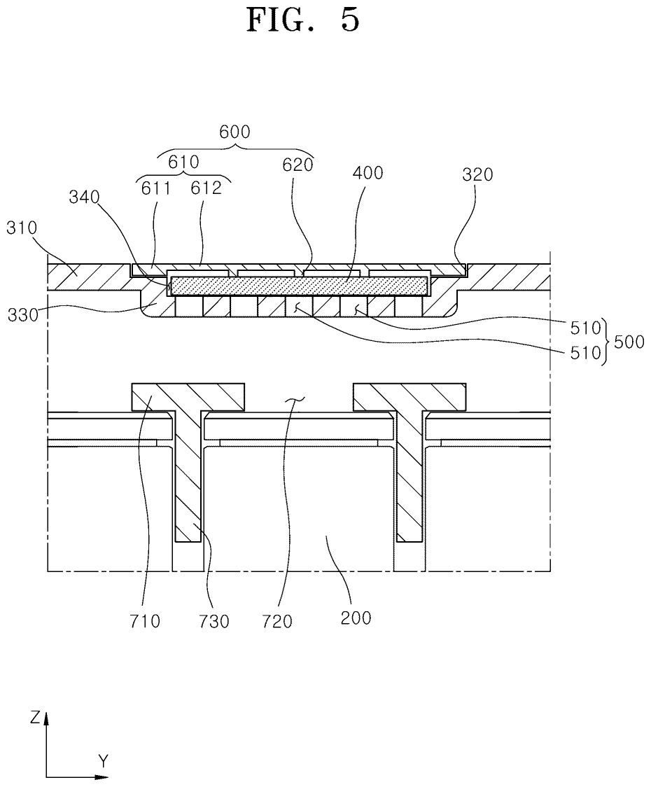

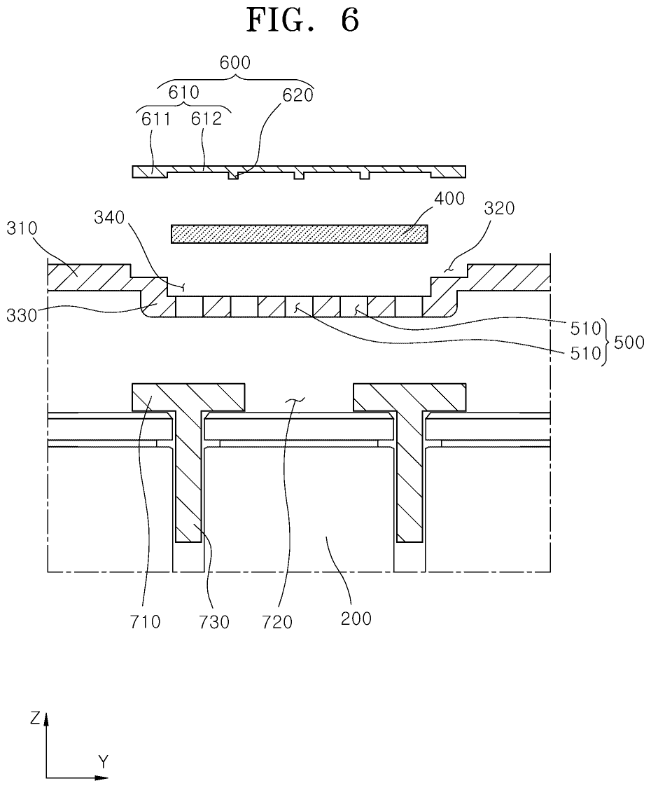

FIG. 4 is an exploded perspective view schematically showing a configuration of a cover, an extinguishing member, and a transfer member according to an embodiment of the present disclosure; FIG. 5 is a cross-sectional view schematically showing a configuration of the cover, the extinguishing member, and the transfer member according to an embodiment of the present disclosure; and FIG. 6 is an exploded cross-sectional view schematically showing a configuration of the cover, the extinguishing member, and the transfer member shown in FIG. 5.

Referring to FIGS. 1 to 6, the cover 300 according to the present embodiment may include a first cover body 310, a first groove 320, a second cover body 330, and a second groove 340.

The first cover body 310 may form a general appearance of the cover 300 and support the second cover body 330.

The first cover body 310 according to the present embodiment may be formed to have a box shape with an empty interior and an open side. The open side of the first cover body 310 may be disposed to face the open side of the housing 100, that is, an upper side surface of the housing 100. Accordingly, the vent V of the battery cell 200 and the first cover body 310 may be disposed to face each other in a direction parallel to the first direction, that is, a vertical direction. The first cover body 310 may be fixed to the housing 100 by any of various types of coupling methods, such as bolting, welding, or fitting. In an embodiment, a thickness of the first cover body 310 may be formed to be the same as a thickness of the housing 100.

The first groove 320 may have a hole shape formed by passing through the first cover body 310. The first groove 320 may vertically pass through the first cover body 310 in the first direction. However, a cross-sectional shape of the first groove 320 may be varied to have any of various shapes, such as a circular or elliptical shape in addition to the rectangular shape shown in FIG. 4.

In an embodiment, the first groove 320 may be provided in plural. The plurality of first grooves 320 may be disposed to be spaced apart from each other in the first cover body 310. However, a number and arrangement of the first grooves 320 may be varied in various ways depending, for example, on a size of the first cover body 310, or the like.

The second cover body 330 may be connected to the first cover body 310 and may be disposed between the first groove 320 and the battery cell 200.

The second cover body 330 according to the present embodiment may refer to a partial area of the cover 300 that is disposed to face the first groove 320 in the first direction among an entire area of the cover 300. The second cover body 330 may protrude in the first direction from a lower surface of the first cover body 310. In an embodiment, a peripheral area of the second cover body 330 may be integrally formed with the first cover body 310. In another embodiment, the peripheral area of the second cover body 330 may be separately manufactured from the first cover body 310 and coupled to the first cover body 310 by any of various types of coupling methods, such as welding or bolting. An upper surface of the second cover body 330 may be disposed to face a lower side area of the first groove 320 in the first direction.

The second cover body 330 may be provided in plural. A number of second cover bodies 330 may be the same as the number of first grooves 320. Each second cover body 330 may be disposed to face a different or respective first groove 320.

The second groove 340 may be disposed inside the second cover body 330. The second groove 340 may provide a space inside the second cover body 330 to accommodate the extinguishing member 400 described below.

The second groove 340 according to the present embodiment may have a groove shape that is formed to be concave from the upper surface of the second cover body 330 in the first direction. An upper side area of the second groove 340 may be connected to the lower side area of the first groove 320. Accordingly, the first groove 320 and the second groove 340 may have the form of an empty space extending continuously from an outer surface of the first cover body 310 toward the inside of the second cover body 330. A cross-sectional shape of the second groove 340 may be formed to be the same as that of the first groove 320, or may be formed differently from the cross-sectional shape of the first groove 320.

A cross-sectional area of the second groove 340 perpendicular to the first direction may be smaller than a cross-sectional area of the first groove 320 perpendicular to the first direction. Accordingly, a stepped surface on which a separate component other than the extinguishing member 400 may be seated, may be formed at an edge area of the upper surface of the second cover body 330 disposed around (e.g., to surround) the second groove 340.

The extinguishing member 400 may suppress a thermal runaway or ignition phenomenon of the battery cell 200 by supplying an extinguishing material to the battery cell 200 during the thermal runaway or ignition of the battery cell 200.

The extinguishing member 400 may be heated by flames or gas generated from the battery cell 200 during the thermal runaway or ignition of the battery cell 200 and then transferred from the transfer member 500 described below. As the extinguishing member 400 is heated above a certain temperature (e.g., a set temperature), an extinguishing material may be supplied to the internal space of the housing 100 and the battery cell 200 through the transfer member 500.

In an embodiment, the extinguishing member 400 may be in a solid form below the certain temperature (e.g., the set temperature) and may be configured to spray an extinguishing material in the form of an aerosol through a combustion reaction thereof above the certain temperature (e.g., the set temperature).

In an embodiment, the extinguishing member 400 may be configured to spray the extinguishing material inside the finishing or exterior material as the finishing or exterior material physically changes (e.g., breaks, ruptures, melts) or undergoes a phase transition above a certain temperature (e.g., a set temperature).

The extinguishing material may be in a solid state, such as powder, or in a liquid or gas state. The extinguishing material may include any of various materials with an extinguishing function, such as any of sodium bicarbonate (NaHCO₃), potassium bicarbonate (KHCO₃), or a mixture of potassium bicarbonate (KHCO₃) and urea ((NH₂)₂CO), a halogen compound, a halon, a water-based extinguishing agent, and carbon dioxide, etc.

The extinguishing member 400 according to the present embodiment may be formed in a generally sheet shape. The extinguishing member 400 may be disposed to face the battery cell 200 with the cover 300 interposed therebetween. The extinguishing member 400 may be inserted into the inside of the second groove 340. Accordingly, when the extinguishing member 400 is damaged or needs to be replaced, a worker can easily replace the extinguishing member 400 from the outside of the cover 300 without disassembling the housing 100 and the cover 300. A cross-sectional area of the extinguishing member 400 may be formed to be the same as or smaller than the cross-sectional area of the second groove 340.

The extinguishing member 400 may be provided in plural. A number of extinguishing members 400 may be formed to be the same as the number of second grooves 340. Each extinguishing member 400 may be individually inserted into a different or respective second groove 340.

The transfer member 500 may be provided in the cover 300. The transfer member 500 may provide a path through which flames, gas, etc., generated from the battery cell 200 during ignition of the battery cell 200 are transferred to the extinguishing member 400 through the second cover body 330, or through which the extinguishing material supplied from the extinguishing member 400 is transferred to the battery cell 200.

The transfer member 500 according to the present embodiment may include a transfer hole 510.

The transfer hole 510 may have a hole shape passing through the second cover body 330.

The transfer hole 510 may be provided in plural. The plurality of transfer holes 510 may be disposed to be spaced apart from each other inside the second cover body 330. However, an arrangement of the plurality of transfer holes 510 is not limited to that shown in FIG. 4 and various design changes are possible within the range of connecting a space between the second cover body 330 and the battery cell 200 and a space between the second cover body 330 and the extinguishing member 400.

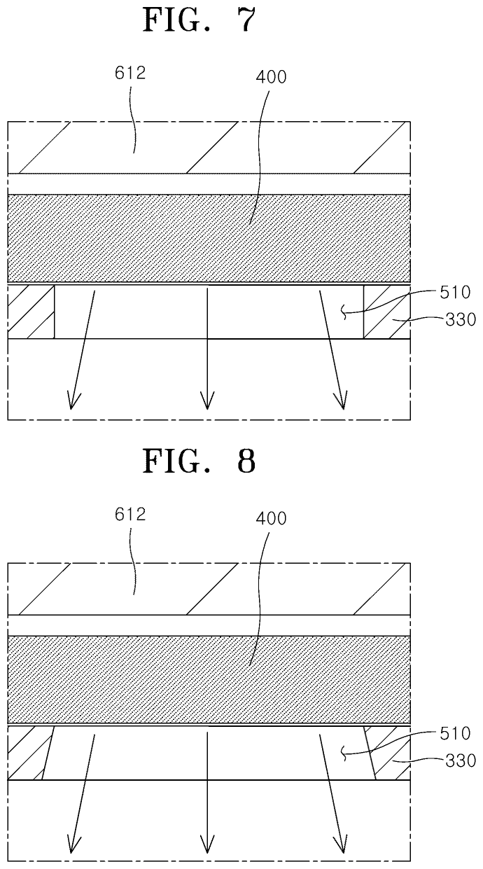

FIG. 7 is an enlarged view schematically showing a configuration of a transfer hole according to an embodiment of the present disclosure.

Referring to FIGS. 1 to 7, the transfer hole 510 according to the present embodiment may vertically pass through the second cover body 330 in the first direction. Both sides of the transfer hole 510 may be disposed to face the battery cell 200 and the extinguishing member 400, respectively. However, a cross-sectional shape of the transfer hole 510 is not limited to the shape shown in FIG. 7 and may have any of various shapes, such as circular, elliptical, and polygonal shapes. In an embodiment, a cross-sectional area of the transfer hole 510 perpendicular to the first direction may be formed to be constant in all sections.

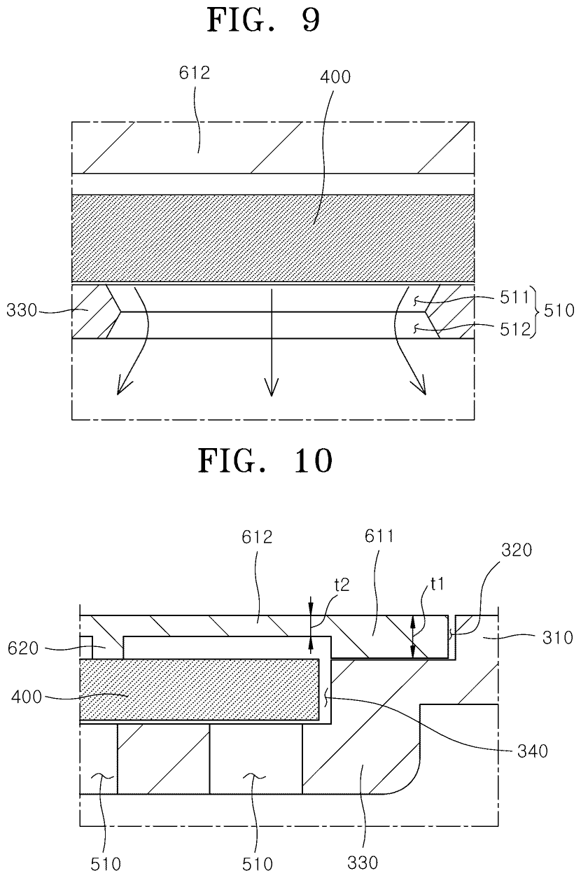

FIGS. 8 and 9 are views showing some other examples of the transfer hole shown in FIG. 7.

Referring to FIG. 8, a cross-sectional area of the transfer hole 510 perpendicular to the first direction may be formed to increase toward the battery cell 200. Accordingly, the transfer hole 510 can improve extinguishing efficiency by inducing the extinguishing material supplied from the extinguishing member 400 to be sprayed over a wider area.

Referring to FIG. 9, the transfer hole 510 may include a first transfer hole 511 and a second transfer hole 512.

The first transfer hole 511 may be disposed to face the extinguishing member 400. The first transfer hole 511 according to the present embodiment may refer to an upper side area of the transfer hole 510 passing through the upper surface of the second cover body 330.

A cross-sectional area of the first transfer hole 511 perpendicular to the first direction may increase toward the extinguishing member 400. Accordingly, the first transfer hole 511 may increase an area in which flames or smoke generated from the battery cell 200 during ignition of the battery cell 200 come into contact with the extinguishing member 400, thereby inducing rapid operation of the extinguishing member 400.

The second transfer hole 512 may be connected to the first transfer hole 511 and disposed to face the battery cell 200. The second transfer hole 512 according to the present embodiment may refer to a lower side area of the transfer hole 510 passing through a lower surface of the second cover body 330.

A cross-sectional area of the second transfer hole 512 perpendicular to the first direction may increase toward the battery cell 200. Accordingly, the second transfer hole 512 can improve extinguishing efficiency by inducing the extinguishing material supplied from the extinguishing member 400 to be sprayed over a wider area.

The battery pack according to the present embodiment may further include a cap 600.

The cap 600 may be disposed inside the first groove 320 and cover the extinguishing member 400. That is, the cap 600 may protect the extinguishing member 400 from an external foreign substance or an impact and prevent or substantially prevent the extinguishing member 400 from being separated from the second groove 340.

The cap 600 may be provided in plural. Each cap 600 may be individually disposed inside a different or respective first groove 320 and may individually cover a different or respective extinguishing member 400.

FIG. 10 is an enlarged view schematically showing a configuration of a cap according to an embodiment of the present disclosure.

Referring to FIGS. 1 to 10, the cap 600 according to the present embodiment may include a cap body 610 and a support rib 620.

The cap body 610 may form a general appearance of the cap 600 and may support the support rib 620. The cap body 610 may be inserted into the first groove 320 in the first direction from the outside of the cover 300. In an embodiment, a cross-sectional shape of the cap body 610 may be formed to be the same as the cross-sectional shape of the first groove 320.

The cap body 610 according to the present embodiment may include a first cap body 611 and a second cap body 612.

The first cap body 611 according to the present embodiment may refer to an edge area of the cap body 610 facing the second cover body 330 among an entire area of the cap body 610. As the cap body 610 is inserted into the first groove 320, a lower surface of the first cap body 611 may be seated on an upper surface of the second cover body 330 disposed around (e.g., to surround) the second groove 340.

An outer surface of the first cap body 611 may be fixed to an inner surface of the first cover body 310 around (e.g., surrounding) the outer periphery of the first groove 320. For example, the outer surface of the first cap body 611 may be fixed to the inner surface of the first cover body 310 by press-fitting or interference fitting, etc., or may be fixed to the inner surface of the first cover body 310 by hook coupling, etc.

The second cap body 612 according to the present embodiment may refer to a central area of the cap body 610 facing the extinguishing member 400 among the entire area of the cap body 610. A cross-sectional area of the second cap body 612 may be the same as or larger than the cross-sectional area of the second groove 340.

A thickness t2 of the second cap body 612 parallel to the first direction may be smaller than a thickness t1 of the first cap body 611 parallel to the first direction. When the internal pressure of the housing 100 increases above a certain pressure (e.g., a set pressure), the second cap body 612 may rupture due to the internal pressure of the housing 100, and a path through which gas, or the like may be discharged outside the housing 100 may thereby be created. Accordingly, the second cap body 612 can prevent or substantially prevent secondary damage such as an explosion in the housing 100 caused by an excessive increase in internal pressure of the housing 100 during ignition of the battery cell 200.

The support rib 620 may extend from the cap body 610 and come into contact with the extinguishing member 400. The support rib 620 may reduce movement of the extinguishing member 400 caused by a difference between the thickness of the extinguishing member 400 and a gap between the cap body 610 and the second cover body 330. Accordingly, the support rib 620 can prevent or substantially prevent a positional change in or damage to the extinguishing member 400 due to an external force or vibration.

The support rib 620 according to the present embodiment may extend in the first direction from a lower surface of the second cap body 612. A lower end portion of the support rib 620 may come into contact with an upper surface of the extinguishing member 400. In an embodiment, a length of the support rib 620 may be the same as a difference between the thickness of the extinguishing member 400 and a gap between the cap body 610 and the second cover body 330.

The support rib 620 may be provided in plural. The plurality of support ribs 620 may be disposed to be spaced apart from each other on the second cap body 612 and may individually come into contact with different parts of the upper surface of the extinguishing member 400 facing the second cap body 612. A number and spacing of the support ribs 620 may be varied in various ways depending, for example, on an area, shape, or the like of the cap body 610.

The battery pack according to the present embodiment may further include a holder 700.

The holder 700 may be disposed between the battery cell 200 and the cover 300. The holder 700 may support the plurality of battery cells 200 inside the housing 100 and maintain a spacing between neighboring battery cells 200.

The holder 700 may include a holder body 710, a vent hole 720, and an alignment member 730.

The holder body 710 may be formed to have a plate shape that is seated on the battery cell 200.

The holder body 710 according to the present embodiment may be formed in a generally flat plate shape. The holder body 710 may be disposed between the upper end portion of the battery cell 200 and a lower surface of the cover 300. An upper surface of the holder body 710 may be disposed to face the lower surface of the cover 300. A lower surface of the holder body 710 may be seated on an upper side surface of the battery cell 200 where the vent V is formed.

The vent hole 720 may pass through the holder body 710 and may be disposed to face the vent V. The vent hole 720 may induce discharge materials, such as flames or gas discharged from the vent V, to be transferred to an internal space of the housing 100 through the holder body 710.

The vent hole 720 according to the present embodiment may have a hole shape vertically passing through the holder body 710. A cross-sectional area of the vent hole 720 may be smaller than a cross-sectional area of the battery cell 200. However, a cross-sectional shape of the vent hole 720 may be varied to have any of various shapes other than the circular shape shown in FIG. 1.

The vent hole 720 may be provided in plural. The plurality of vent holes 720 may be disposed to be spaced apart from each other in the holder body 710. The plurality of vent holes 720 may be disposed to individually face the vent V of a different or respective battery cell 200.

The alignment member 730 may extend from the holder body 710 and may be inserted between neighboring battery cells 200. The alignment member 730 may align a gap between the battery cells 200 to a certain size (e.g., a set size).

The alignment member 730 according to the present embodiment may extend vertically downward from a lower side surface of the holder body 710. Both, or opposite, side surfaces of the alignment member 730 may be disposed around (e.g., to respectively surround) upper circumferential surfaces of a pair of neighboring battery cells 200. The alignment member 730 may be provided in plural. The plurality of alignment members 730 may be individually inserted between each pair of neighboring battery cells 200.

Herein, the operation of the battery pack according to the present embodiment will be described.

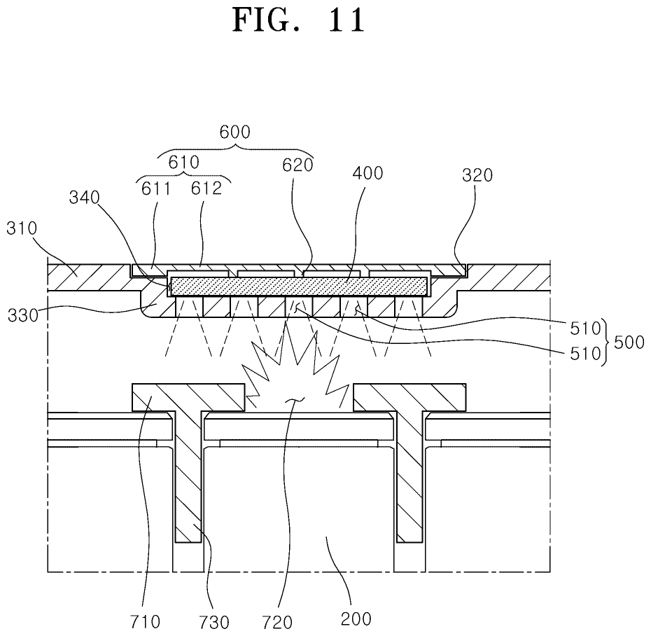

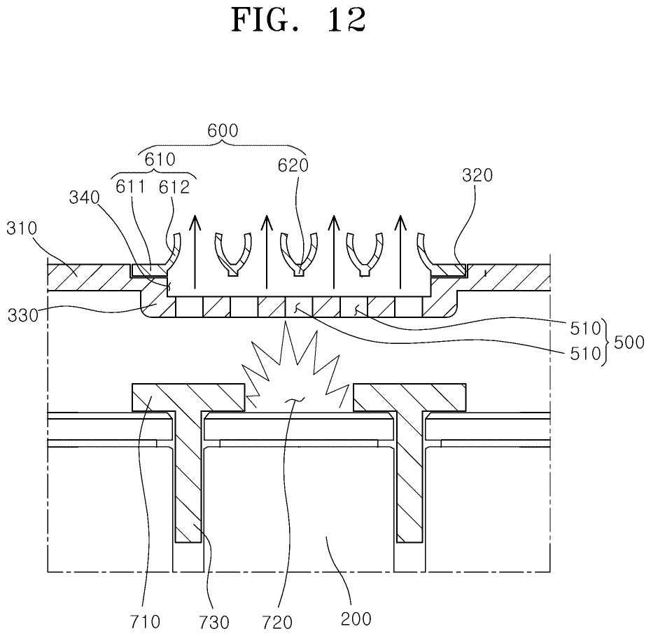

FIGS. 11 and 12 are views schematically showing an operation process of the battery pack according to an embodiment of the present disclosure.

Referring to FIG. 11, if thermal runaway or ignition of any one of the battery cells 200 occurs, a discharge material, such as flames, gas, or smoke, is discharged from the vent V of the battery cell 200.

The discharge material discharged from the vent V may flow into the transfer hole 510 through the internal space of the housing 100 and may be transferred to the extinguishing member 400 through the transfer hole 510.

The extinguishing member 400 may be heated by a temperature of the discharge material discharged from the vent V.

As the temperature of the extinguishing member 400 increases above a certain temperature (e.g., a set temperature), the extinguishing member 400 may spray the extinguishing material to the outside through a chemical action, such as combustion, or a physical action, such as rupture.

The extinguishing material sprayed from the extinguishing member 400 may flow into the internal space of the housing 100 through the transfer hole 510, may be transferred to the battery cell 200, and may extinguish the fire.

Referring to FIG. 12, as gas generated from the battery cell 200 continues to accumulate inside the housing 100, the internal pressure of the housing 100 may increase and pressure may be applied to the second cap body 612 in a direction opposite to the first direction.

As the pressure applied to the second cap body 612 increases above the inherent rigidity of the second cap body 612, the second cap body 612 may rupture, thereby opening the internal space of the housing 100.

The gas or the like accumulated inside the housing 100 may be discharged to the outside of the housing 100 through the ruptured area of the second cap body 612, thereby reducing the internal pressure of the housing 100.

Herein, a configuration of a battery pack according to another embodiment of the present disclosure will be described.

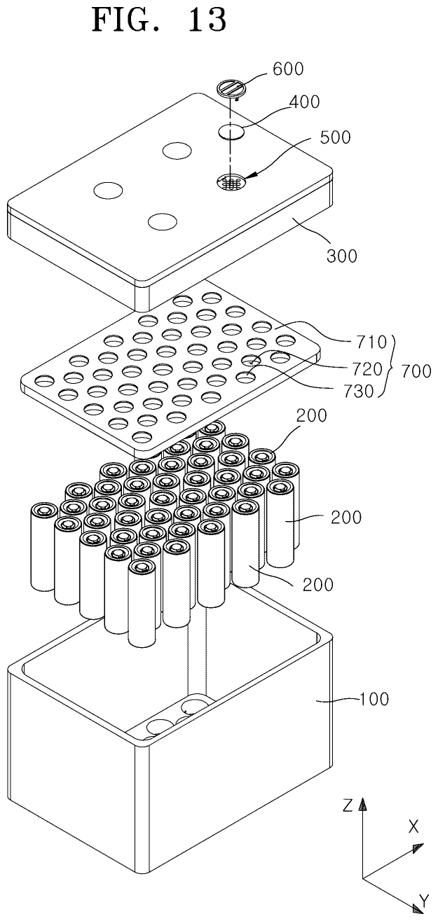

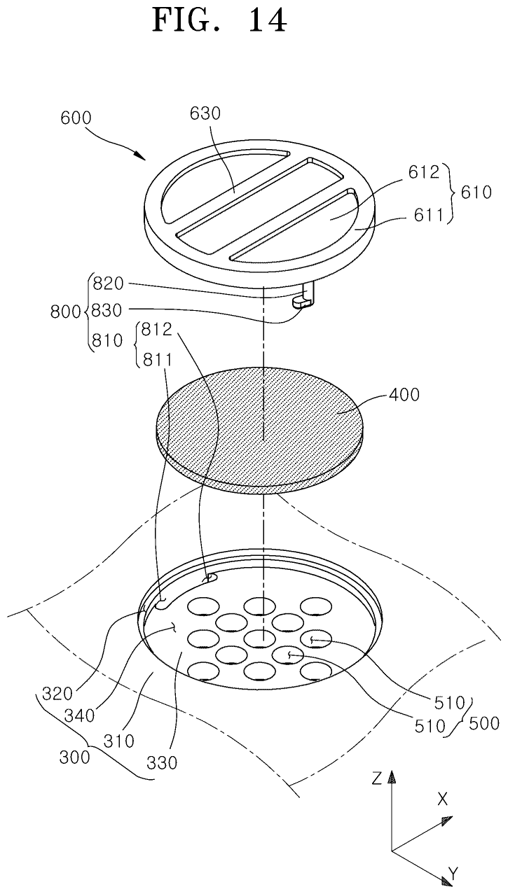

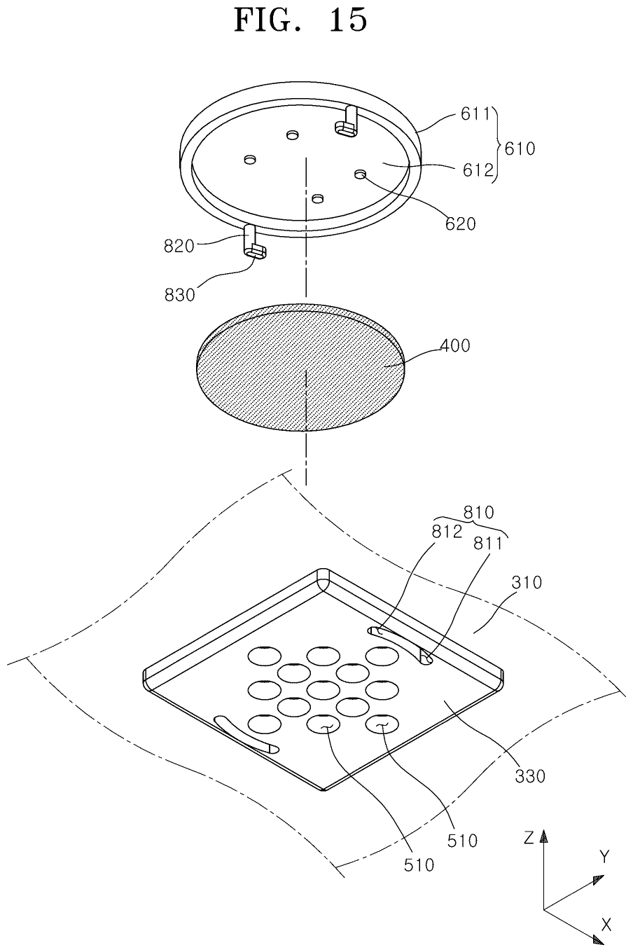

FIG. 13 is an exploded perspective view schematically showing a configuration of a battery pack according to another embodiment of the present disclosure; FIG. 14 is an exploded perspective view schematically showing a configuration of a locking member of the battery pack of FIG. 13; and FIG. 15 is an exploded perspective view schematically showing a configuration of the locking member from a different viewpoint than FIG. 14.

The battery pack according to the present embodiment may be configured so as to differ from the battery pack according to the previously described embodiment in a configuration of the cap body 610 and that it further includes a locking member 800.

In describing the battery pack according to the present embodiment, the configuration of the cap 600 and the locking member 800, which were not described in connection with the battery pack according to the previously described embodiment of the present disclosure, will be described.

For the remaining configuration of the battery pack according to the present embodiment, the contents described in the battery pack according to the previously described embodiment of the present disclosure can be applied as is.

Referring to FIGS. 13 to 15, the cap body 610 according to the present embodiment may be installed in the first groove 320 to be rotatable about the first direction. For example, the cap body 610 may be formed to have a disk shape with a central axis disposed parallel to the first direction. The central axis of the cap body 610 may be disposed to be located coaxially with a central axis of the second cover body 330. The cap body 610 may be rotated clockwise or counterclockwise about the central axis inside the first groove 320. An outer surface of the cap body 610 may be spaced by a distance (e.g., a predetermined distance) from the inner surface of the first cover body 310, or may come into slidable contact with the inner surface of the first cover body 310.

The cap 600 according to the present embodiment may further include a lever, or handle, 630.

The lever 630 may extend in the direction opposite to the first direction from the cap body.

The lever 630 according to the present embodiment may extend in the direction opposite to the first direction from an upper surface of the second cap body 612 disposed to face the outside of the cover 300. A shape of the lever 630 may be formed to have any of various types of handle shapes that can be gripped by a user. Accordingly, a user can freely rotate the cap body 610 clockwise or counterclockwise while gripping the lever 630.

The battery pack according to the present embodiment may further include the locking member 800.

The locking member 800 may interwork with the rotation of the cap body 610 to selectively restrict the cap body 610 from moving in the direction opposite to the first direction. That is, when the cap body 610 is rotated in any one direction of clockwise and counterclockwise while the cap body 610 is inserted into the first groove 320, the locking member 800 may prevent or substantially prevent the cap body 610 from being separated from the first groove 320 by restricting the movement of the cap body 610 in the direction opposite to the first direction. In addition, when the cap body 610 is rotated in the other direction of clockwise and counterclockwise while the cap body 610 is inserted into the first groove 320, the locking member 800 may allow the cap body 610 to be separated from the first groove 320 by allowing the cap body 610 to move in the direction opposite to the first direction.

The locking member 800 according to the present embodiment may include a guide rail 810, a guide rod 820, and a stopper rod 830.

The guide rail 810 may be provided in the second cover body 330 and may guide the movement of the guide rod 820 described below

The guide rail 810 according to the present embodiment may have a hole shape vertically passing through the second cover body 330 in the first direction.

The guide rail 810 may include a first end portion 811 and a second end portion 812 spaced apart in a direction intersecting the first direction. For example, a cross-section of the guide rail 810 perpendicular to the first direction may have an arc shape with a central axis of the second cover body 330 as a center, and the first end portion 811 and the second end portion 812 are formed at both, or opposite, end portions. A curvature of the guide rail 810 may be formed to have a curvature corresponding to a rotational path of the guide rod 820 described below.

The guide rail 810 may be provided in plural. The plurality of guide rails 810 may be arranged at intervals (e.g., set intervals) along an edge area of the second cover body 330 about the central axis of the second cover body 330. However, a number, spacing, or the like of the guide rails 810 may be varied in various ways depending on, for example, an area or the like of the second cover body 330.

The guide rod 820 may extend from the cap body 610 and may be inserted into the guide rail 810.

The guide rod 820 according to the present embodiment may have a rod shape extending from a lower surface of the first cap body 611 seated on the upper surface of the second cover body 330. The guide rod 820 may be disposed parallel to the first direction. As the first cap body 611 is seated on the second cover body 330, the guide rod 820 may be inserted into the guide rail 810, and a lower end portion of the guide rod 820 may protrude downward from the guide rail 810.

The guide rod 820 may be moved toward the first end portion 811 or the second end portion 812 inside the guide rail 810 according to a rotational direction of the cap body 610. For example, when the cap body 610 is moved in either the clockwise or counterclockwise direction, the guide rod 820 may be moved from the first end portion 811 toward the second end portion 812 along the guide rail 810. When the cap body 610 is moved in the other direction of clockwise or counterclockwise, the guide rod 820 may be moved from the second end portion 812 toward the first end portion 811 along the guide rail 810.

The guide rod 820 may be provided in plural. A number of guide rods 820 may be the same as the number of guide rails 810. Each guide rod 820 may be individually inserted into a different or respective guide rail 810.

The stopper rod 830 may extend from the guide rod 820 and restrict or allow the guide rod 820 to move in the direction opposite to the first direction.

The stopper rod 830 according to the present embodiment may be formed to have a rod shape extending from the lower end portion of the guide rod 820. The stopper rod 830 may be disposed to intersect the first direction. For example, the stopper rod 830 may extend from the lower end portion of the guide rod 820 along a tangential direction of a rotational path of the guide rod 820 about the central axis of the cap body 610.

The second cover body 330 and the stopper rod 830 may be sequentially disposed in the first direction. That is, as the lower end portion of the guide rod 820 may protrude downward from the guide rail 810, the stopper rod 830 may be disposed at a location spaced by a distance (e.g., a predetermined distance) downward from the second cover body 330.

When the guide rod 820 is located at the first end portion 811, the stopper rod 830 may be disposed to directly face the guide rail 810 in the first direction. Accordingly, when the guide rod 820 is located at the first end portion 811, the stopper rod 830 may allow the guide rod 820 to move in the direction opposite to the first direction while passing through the guide rail 810. A shape, area, or the like of the stopper rod 830 may be varied in various ways such that the stopper rod 830 may smoothly, or easily, pass through the guide rail 810 in the first direction or in the direction opposite to the first direction when the guide rod 820 is located at an initial position.

When the guide rod 820 is located at the second end portion 812, the stopper rod 830 may be disposed to directly face the second cover body 330 in the first direction. Accordingly, when the guide rod 820 is located at the second end portion 812, the stopper rod 830 may restrict the guide rod 820 from moving in the direction opposite to the first direction by coming into contact with the second cover body 330.

Herein, the operation of the locking member 800 according to the present embodiment of the present disclosure will be described.

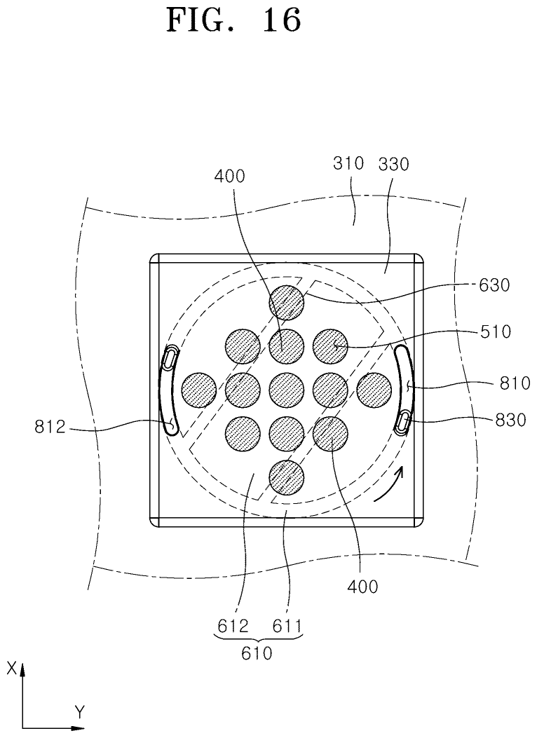

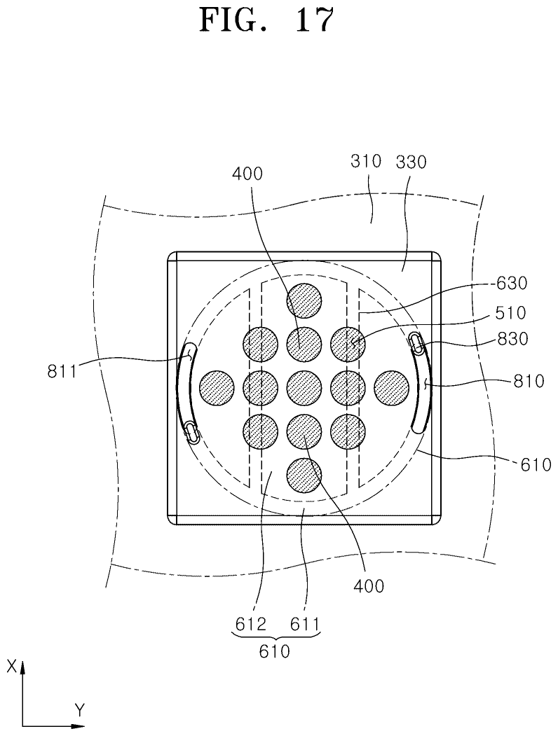

FIGS. 16 and 17 are views schematically showing an operation process of the locking member according to the present embodiment of the present disclosure.

Referring to FIGS. 16 and 17, as the first cap body 611 is seated on the second cover body 330, the guide rod 820 may be inserted into the guide rail 810.

Thereafter, in order to fix the cap body 610 to the first groove 320, a user rotates the cap body 610 in a locking direction (e.g., counterclockwise based on FIG. 16) while holding the lever 630.

As the cap body 610 rotates in the locking direction, the guide rod 820 may move from the first end portion 811 toward the second end portion 812.

As the guide rod 820 is located at the second end portion 812, the stopper rod 830 may be disposed to directly face the second cover body 330 in the first direction.

Thereafter, when an external force is applied to the cap body 610 in the direction opposite to the first direction, the stopper rod 830 may restrict the cap body 610 from moving in the direction opposite to the first direction by coming into contact with the second cover body 330.

When separating the cap body 610 from the first groove 320, a user rotates the cap body 610 in an unlocking direction (clockwise based on FIG. 17) while holding the lever 630.

As the cap body 610 rotates in the unlocking direction, the guide rod 820 may move from the second end portion 812 toward the first end portion 811.

As the guide rod 820 is located at the first end portion 811, the stopper rod 830 may be disposed to directly face the guide rail 810 in the first direction.

Thereafter, when an external force is applied to the cap body 610 in the direction opposite to the first direction, the stopper rod 830 may allow the cap body 610 to move in the direction opposite to the first direction while passing through the guide rail 810.

According to one or more embodiments of the present disclosure, flames generated inside a housing due to thermal runaway of a battery cell can be quickly extinguished by an extinguishing member.

According to one or more embodiments of the present disclosure, when the extinguishing member is damaged or needs to be replaced, the extinguishing member can be easily replaced from the outside of a cover without disassembling the housing and the cover.

According to one or more embodiments of the present disclosure, a transfer member can ensure that flames generated during ignition of the battery cell smoothly, or easily, come into contact with the extinguishing member, and an extinguishing material supplied from the extinguishing member can be smoothly, or easily, transferred to the battery cell.

According to one or more embodiments of the present disclosure, a cap can protect the extinguishing member from external foreign substances or impacts and can prevent or substantially prevent the extinguishing member from detaching from a second groove.

However, aspects and effects obtainable through the present disclosure are not limited to the above aspects and effects, and other technical aspects and effects that are not mentioned will be clearly understood by those skilled in the art from the description of the present disclosure.

While the present disclosure has been described with reference to some embodiments shown in the drawings, these embodiments are merely illustrative and it is to be understood that various modifications and equivalent other embodiments can be derived by those skilled in the art on the basis of the embodiments.

Therefore, the technical scope of the present disclosure should be defined by the claims.

What is claimed is:

1. A battery pack comprising:
a housing;
a battery cell inside the housing and comprising a vent;
an extinguishing member outside the housing and configured to supply an extinguishing material if the battery cell ignites;
a cover between the battery cell and the extinguishing member; and
a transfer member arranged in the cover and configured to transfer the extinguishing material supplied from the extinguishing member to the battery cell.

2. The battery pack as claimed in claim 1, wherein the vent faces the cover.

3. The battery pack as claimed in claim 1, wherein the cover comprises:
a first cover body;
a first groove passing through the first cover body;
a second cover body connected to the first cover body and located between the first groove and the battery cell; and
a second groove in the second cover body, connected to the first groove, and in which the extinguishing member is inserted.

4. The battery pack as claimed in claim 3, wherein the second cover body protrudes from the first cover body toward the battery cell.

5. The battery pack as claimed in claim 3, wherein a cross-sectional area of the second groove is smaller than a cross-sectional area of the first groove.

6. The battery pack as claimed in claim 3, wherein the transfer member comprises a transfer hole passing through the second cover body and arranged to face the extinguishing member and the battery cell.

7. The battery pack as claimed in claim 6, wherein a cross-sectional area of the transfer hole increases toward the battery cell.

8. The battery pack as claimed in claim 6, wherein the transfer hole comprises:
a first transfer hole facing the extinguishing member; and
a second transfer hole connected to the first transfer hole and facing the battery cell.

9. The battery pack as claimed in claim 8, wherein a cross-sectional area of the first transfer hole increases toward the extinguishing member, and
a cross-sectional area of the second transfer hole increases toward the battery cell.

10. The battery pack as claimed in claim 3, further comprising a cap in the first groove and covering the extinguishing member.

11. The battery pack as claimed in claim 10, wherein the cap comprises:
a cap body inserted in the first groove in a first direction; and
a support rib extending from the cap body in the first direction and in contact with the extinguishing member.

12. The battery pack as claimed in claim 11, wherein the cap body comprises:
a first cap body seated on the second cover body; and
a second cap body connected to the first cap body and facing the extinguishing member.

13. The battery pack as claimed in claim 12, wherein a thickness of the second cap body is thinner than a thickness of the first cap body.

14. The battery pack as claimed in claim 11, wherein the cap body is arranged in the first groove to be rotatable about the first direction, and
the battery pack further comprises a locking member configured to interwork with rotation of the cap body to selectively restrict the cap body from moving in a direction opposite to the first direction.

15. The battery pack as claimed in claim 14, wherein the cap further comprises a lever extending from the cap body in the direction opposite to the first direction.

16. The battery pack as claimed in claim 14, wherein the locking member comprises:
a guide rail passing through the second cover body and comprising a first end portion and a second end portion;
a guide rod extending from the cap body, inserted into the guide rail, and movable toward the first end portion or the second end portion according to a rotational direction of the cap body; and
a stopper rod extending from the guide rod, facing the guide rail when the guide rod is located at the first end portion, and facing the second cover body when the guide rod is located at the second end portion.

17. The battery pack as claimed in claim 16, wherein the first end portion and the second end portion are spaced apart in a direction intersecting the first direction.

18. The battery pack as claimed in claim 16, wherein the guide rod is arranged parallel to the first direction, and the stopper rod is arranged to intersect the first direction.

19. The battery pack as claimed in claim 16, wherein the second cover body and the stopper rod are sequentially arranged in the first direction.
